(19) United States
(12) Patent Application Publication
(10) Pub. No.: US 2020/0064781 A1
(43) Pub. Date: Feb. 27, 2020

(54) WATCH-TYPE TERMINAL

(71) Applicant: LG ELECTRONICS INC., Seoul (KR)

(72) Inventors: Hongjo SHIM, Seoul (KR); Hyunok LEE, Seoul (KR); Mihyun PARK, Seoul (KR); Kyoungjin LEE, Seoul (KR); Sungjin LEE, Seoul (KR)

(73) Assignee: LG ELECTRONICS INC., Seoul (KR)

(21) Appl. No.: 16/346,863

(22) PCT Filed: Nov. 24, 2016
(86) PCT No.: PCT/KR2016/013653

§ 371 Date: May 1, 2019

(30) Foreign Application Priority Data
Nov. 8, 2016 (KR) 10-2016-0148273

(51) Int. Cl. G04R 60/06; G01P 3/26; G04G 21/02; G04G 21/04; G04G 9/00; H04B 1/3827

(52) U.S. Cl. CPC G04R 60/06; G01P 3/26; H04B 1/3827; G04G 21/04; G04G 9/0064; G04G 21/025

(57) ABSTRACT

Provided is a watch-type terminal comprising: a main body which can be mounted on an area of a human body; a pressure sensor which is mounted on an area of the main body in an on-land mode and detects an external pressure change; and a control unit which switches the on-land mode to an underwater mode and controls the execution of a particular function, in case the pressure change is greater than or equal to a preset reference change amount.

### TECHNICAL FIELD

The present invention relates to a watch-type terminal worn on a wrist and capable of operating in water.

### BACKGROUND ART

A mobile terminal includes any type of device which has a battery and a display unit, outputs information to the display unit by using power supplied from the battery, and is portable by a user. A mobile terminal includes a device for recording and playing a video, a device for displaying a graphic user interface (GUI), and the like, and includes laptops, mobile phones, glasses, watches, and gaming consoles which can display screen information, etc.

As the functions of such a mobile terminal are diversified, the mobile terminal is implemented in the form of a multimedia player having complex functions such as, for example, imaging of pictures or videos, playing of music or video files, gaming, receiving of broadcasts, and the like. To support and enhance functionality of such a mobile terminal, it can be considered to improve a structural part and/or a software part of the mobile terminal.

Recently, a waterproof watch-type terminal that can be used in water has been developed. Accordingly, a pressure sensor capable of detecting underwater pressure is additionally included. In this case, when a waterproof material such as Gore-Tex is used to waterproof an area where the pressure sensor is seated, there is a problem in that the pressure sensor can not withstand a high pressure in deep water. Also, in order to execute a specific function in water, there is an inconvenience that a user has to apply a control command for switching to an underwater mode.

### DETAILED DESCRIPTION OF THE INVENTION

### Technical Problem

Thus, the present invention is directed to providing a watch-type terminal capable of detecting a pressure change and being controlled depending on whether the terminal is in water.

### Technical Solution

In order to achieve the objective of the present invention, a watch-type terminal according to an embodiment includes a main body capable of being mounted on a region of a human body, a pressure sensor mounted on a region of the main body in an on-land mode and configured to detect an external pressure change; and a control unit configured to switch the on-land mode to an underwater mode to control execution of a specific function when the pressure change is greater than or equal to a predetermined reference change amount.

As an example related to the present invention, when the underwater mode is activated, the control unit may execute a first function corresponding to the underwater mode and block execution of a second mode corresponding to the on-land mode. Accordingly, the user does not need to apply a control command for switching the mode to perform a specific function to be used at the time of water entry.

As an example related to the present invention, the water-type terminal may further include a first sensor configured to detect rotation and a second sensor configured to detect speed in order to form swimming pattern data along with the pressure sensor in the underwater mode, wherein the control unit may compare a current battery remaining amount to a reference amount and sequentially deactivate the first sensor and the second sensor. Accordingly, it is possible to efficiently record the swimming pattern data according to the battery remaining amount.

As an example related to the present invention, an o-ring is formed in the vicinity of the pressure sensor to prevent inflow of water and a vent hole or the like is formed such that direct contact with external air occurs. Thus, it is possible to accurately detect pressure, and also Gore-Tex materials need not be used. Accordingly, pressure detection is possible even in deep water regions.

### Advantageous Effects of the Invention

According to the present invention, since movement into water is detected and thus the mode is changed to the underwater mode, a user can perform an appropriate function in water without a control command for switching to an underwater mode and executing a specific function.

Also, since waterproof is achieved by an O-RING and the pressure sensor is formed in direct contact with an external space, it is possible to accurately detect pressure even in deep water regions.

Further, when it is detected that the user is located in water, warning information may be formed by other sensing units and collected information, thus improving the safety of the user in the water.

### DESCRIPTION OF THE DRAWINGS

FIG. 1A is a block diagram illustrating elements of a watch-type terminal according to the present invention.

FIGS. 1B and 1C are views of a watch-type terminal according to another embodiment of the present invention when viewed from different directions.

FIG. 2 is a graph illustrating a pressure change measured by a pressure sensor of the present invention.

FIGS. 3A and 3B are conceptual diagrams illustrating the structure of a pressure sensor unit according to an embodiment of the present invention.

FIGS. 4A and 4B are conceptual diagrams illustrating the structure of a pressure sensor unit according to another embodiment.

FIG. 5A is a flowchart illustrating a method of controlling a watch-type terminal according to an embodiment.

FIG. 5B is a conceptual diagram illustrating a method of controlling a watch-type terminal according to an embodiment of the present invention.

FIGS. 5C to 5E are conceptual diagrams illustrating a method of controlling a watch-type terminal according to still another embodiment of the present invention.

FIG. 6A is a flowchart illustrating a method of controlling a watch-type terminal according to another embodiment of the present invention.

FIG. 6B is a conceptual diagram illustrating a stroke pattern detected by at least one sensor included in a sensing unit of the present invention.

FIG. 6C is a conceptual diagram illustrating sensors activated to acquire swimming tracking information.

FIG. 6D is a conceptual diagram showing a pressure change detected by a pressure sensor during underwater swimming

FIGS. 7A to 7F are conceptual diagrams illustrating a method of controlling a watch-type terminal according to an embodiment of the present invention.

FIGS. 8A to 8D are conceptual diagrams illustrating a control method for outputting warning information according to an embodiment of the present invention.

### MODE OF THE INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

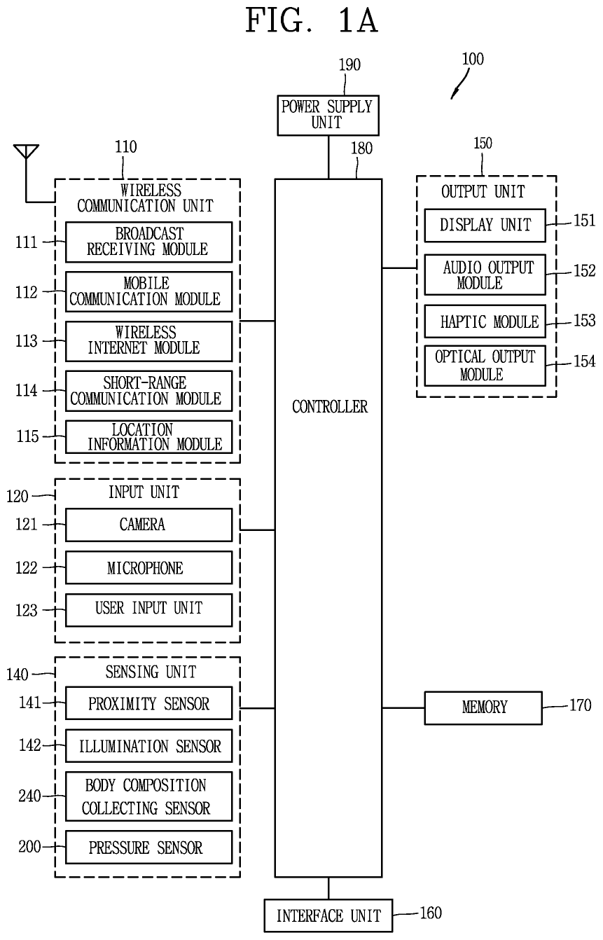

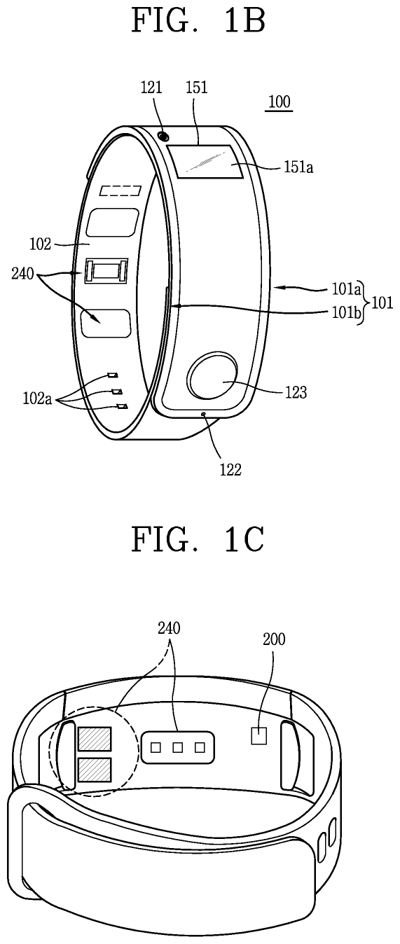

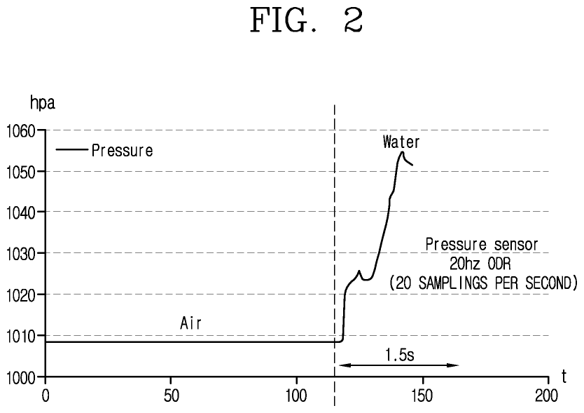

FIG. 1A is a conceptual diagram of an example of a watch-type terminal according to the present invention when viewed from one direction.

The watch-type terminal 100 may include a wireless communication unit 110, an input unit 120, a sensing unit 140, an output unit 150, an interface unit 160, a memory 170, a control unit 180, a power supply unit 190, and the like. The above elements are not essential for implementing the watch-type terminal, so that the watch-type terminal described herein may have more or fewer elements than the elements listed above.

In detail, among the elements, the wireless communication unit 110 may include one or more modules capable of wireless communication between the watch-type terminal 100 and a wireless communication system, between the watch-type terminal 100 and another watch-type terminal 100, or between the watch-type terminal 100 and an external server. Also, the wireless communication unit 110 may include one or more modules for connecting the watch-type terminal 100 to one or more networks.

The wireless communication unit 110 may include at least one of a broadcast receiving module 111, a mobile communication module 112, a wireless Internet module 113, a short-range communication module 114, and a location information module 115.

The input unit 120 may be composed of a camera 121 or an image input unit for receiving image signals, a microphone 122 or an audio input unit for receiving audio signals, and a user input unit 123 (e.g., a touch key or a push key (mechanical key)) for receiving information from a user. Also, the input unit 120 may further include the camera 121 or the image input unit for receiving image signals or the microphone 122 or the audio input unit for receiving audio signals. Voice data or image data collected by the input unit 120 may be analyzed and processed according to a user's control command

The sensing unit 140 may include one or more sensors for detecting at least one of information regarding the watch-type terminal, information regarding an environment surrounding a mobile terminal, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, a red-green-blue (RGB) sensor, an infrared (IR) sensor, a finger scan sensor, an ultrasonic sensor, an optical sensor (e.g., a camera 121), a microphone 122, a battery gauge, an environmental sensor (e.g., a barometer, a hygrometer, a thermometer, a radiation detection sensor, a heat detection, a gas detection sensor, etc.), and a chemical sensor (e.g., an electronic nose, a healthcare sensor, a biometric sensor, etc.). Meanwhile, the mobile terminal disclosed herein may utilize pieces of information detected by two or more of the sensors in combination.

The output unit 150 is intended to generate an output related to visual, auditory, and tactile senses and may include a display unit 151, an acoustic output unit 152, a haptic module 153, and a light output unit 154. The display unit 151 may be implemented as a touch screen by forming a mutual layer structure together with a touch sensor or by integrating with a touch sensor. Such a touch screen may function as a user input unit for providing an input interface between the watch-type terminal 100 and the user and also may provide an output interface between the watch-type terminal 100 and the user.

The interface unit 160 serves as a passage to various kinds of external devices connected to the watch-type terminal 100. Such an interface unit 160 may include at least one of a wired/wireless headset port, an external charger port, a wired/wireless data port, a memory card port, a portion for coupling to a device with an identity module, an audio input/output (I/O) port, a video I/O port, and an earphone port. In response to an external device being connected to the interface unit (not shown), the watch-type terminal 100 may perform appropriate control actions related to the connected external device.

Also, the memory 170 stores data for supporting various functions of the watch-type terminal 100. The memory 170 may store multiple application programs or applications running in the watch-type terminal 100 and data and commands for operation of the watch-type terminal 100. At least some of the application programs may be downloaded from an external server through wireless communication. At least some of the application programs may reside in the watch-type terminal 100 from the time of release for basic functions (e.g., voice origination/termination functions or message origination/termination functions) of the watch-type terminal 100. Meanwhile, the application programs may be stored in the memory 170, installed in the watch-type terminal 100, and executed by the control unit 180 to perform operations (or functions) of the mobile terminal.

Typically, the control unit 180 controls the overall operation of the watch-type terminal 100, in addition to an operation related to the application program. The control unit 180 may provide or process information or functions appropriate to a user by processing signals, data, information, and the like which are input or output through the above elements or executing the application programs stored in the memory 170.

Also, the control unit 180 may control at least some of the elements described with reference to FIG. 1A in order to execute the application programs stored in the memory 170. Furthermore, in order to execute the application program, the control unit 180 may operate at least two of the elements included in the watch-type terminal 100 in combination.

Under control of the control unit 180, the power supply unit 190 receives external power or internal power and supply the power to each element included in the watch-type terminal 100. Such a power supply unit 190 may include a battery, and the battery may be a built-in battery or a rechargeable battery.

At least some of the above elements may operate in collaboration with each other in order to implement operation or control of a mobile terminal or a method of controlling a mobile terminal according to various embodiments, which will be described below. Also, the operation, control, or control method of the mobile terminal may be implemented on the mobile terminal by executing at least one of the application programs stored in the memory 170.

FIG. 1B is a perspective view showing an example of the watch-type terminal 100 according to another embodiment of the present invention.

Referring to FIG. 1B, the watch-type terminal 100 includes a main body including a display unit 151 and a band 102 connected to the main body 101 and capable of being worn on a wrist. The main body 101 includes a casing forming an external appearance. As shown, the casing may include a first casing 101a and a second casing 101b that provide an inner space for accommodating various kinds of electronic components. However, the present invention is not limited thereto, and one casing is configured to provide the inner space so that the watch-type terminal 100 may be implemented to have a single body.

The watch-type terminal 100 is configured to be capable of wireless communication, and an antenna for the wireless communication may be installed in the main body 101. Meanwhile, the antenna may expand its performance by using the casing. For example, the casing including a conductive material may be electrically connected to the antenna and may be configured to expand a ground region or a radiation region.

The display unit 151 may be disposed on a front surface of the main body 101 to output information, and a touch sensor may be provided on the display unit 151 and thus implemented as a touchscreen. As shown, a window 151a of the display unit 151 may be mounted on the first casing 101a to form the front surface of the terminal body together with the first casing 101a.

An acoustic output unit 152, a camera 121, a microphone 122, a user input unit 123, and the like may be included in the main body 101. When the display unit 151 is implemented as a touch screen, the display unit 151 may function as the user input unit 123, so that a separate key may not be provided in the main body 101.

The band 102 may be worn on a wrist to surround the wrist, and may be made of a flexible material for easy wearing. As an example, the band 102 may be made of leather, rubber, silicone, synthetic resin, or the like. Also, the band 102 may be detachably attached to the main body 101 and may be replaced with various types of bands according to the user's preference.

Meanwhile, the band 102 may be used to expand the antenna's performance. For example, the band 102 may have a ground expansion (not shown) electrically connected to the antenna to expand the ground region.

A fastener 102a may be provided in the band 102. The fastener 102a may be implemented by a buckle, a hook structure capable of snap-fit, or Velcro (a trademark) and may include a stretchable section or material. In this drawing, an example in which the fastener 102a is embodied as a buckle is shown.

The watch-type terminal 100 according to an embodiment of the present invention further includes a pressure sensor 200. The pressure sensor 200 may sense pressure at the current location of the watch-type terminal 100, and the pressure sensor 200 may sense pressure in nearby regions when the watch-type terminal 100 is located on land and in water. Also, the watch-type terminal 100 further includes a body composition collecting sensor 240 for collecting biometric information. The body composition collecting sensor 240 may include a photoplethysmography (PPG) sensor, an electrode for collecting body fat information, and the like.

The structure of a pressure sensor, a method of controlling the watch-type terminal 100 using the pressure sensor, and a swimming pattern data collecting method will be described below.

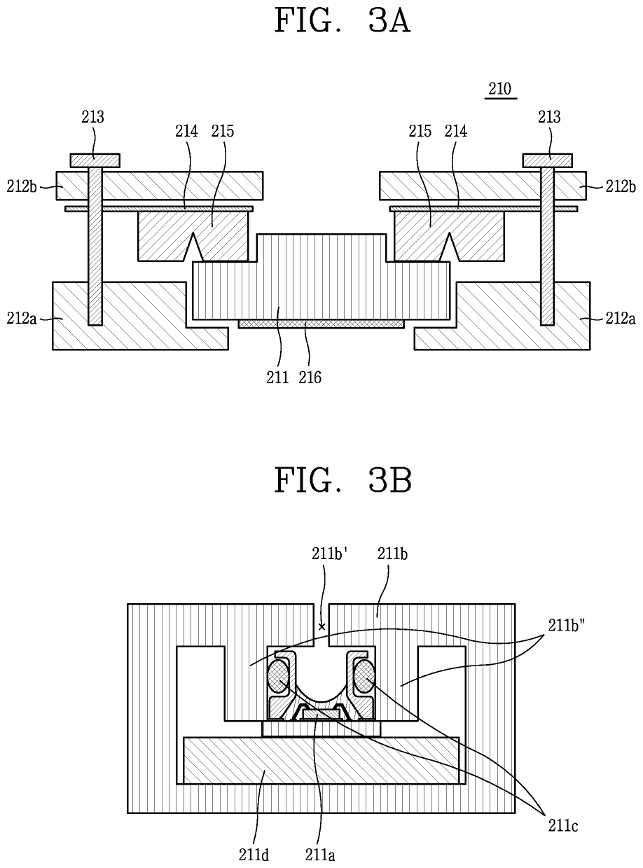

FIG. 2 is a graph illustrating a pressure change measured by a pressure sensor of the present invention.

A pressure sensor 200 installed in the watch-type terminal 100 collects pressure data both on data and in water. The control unit 180 may control the pressure sensor 200 to collect pressure data at predetermined reference intervals.

The pressure measured by the pressure sensor 200 has a pressure value within a specific range without relatively great ups and downs on land. However, when the watch-type terminal 100 moves from land to water, the pressure value increases in a relatively large amount within a certain time. As shown in FIG. 2, it can be seen that the pressure value increases by about 40 hPa in about 1.5 seconds.

That is, when the pressure value detected by the pressure sensor 200 is increased (changed) by a reference value or more within a specific time, the control unit may determine that the watch-type terminal 100 moves from land to water or from water to land. Thus, the control unit 180 may change a functional execution state or execute a specific function on the basis of the pressure change.

The structural characteristics of the pressure sensor 200 for detecting pressure in water will be described first, and then a method of controlling the watch-type terminal 100 when the watch-type terminal 100 moves to water will be described.

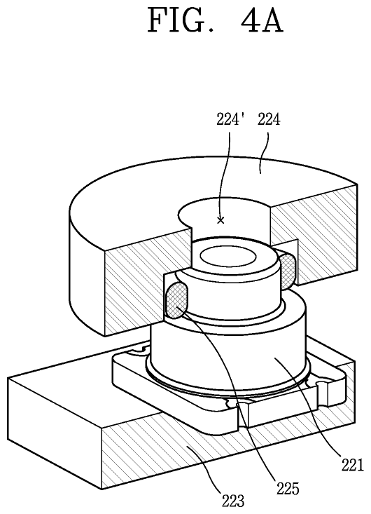

FIGS. 3A and 3B are conceptual vies illustrating the structure of a pressure sensor unit according to an embodiment of the present invention.

A pressure sensor unit 210 according to FIGS. 3A and 3B includes a pressure sensor module 211, first and second bodies 212a and 212b configured to accommodate the pressure sensor module 211, a plate 214, and a first O-ring 215 configured to elastically support the pressure sensor module 211 between the first and second bodies 212a and 212b.

The first body 212a may be formed stepwise so that the pressure sensor module 211 with a first circuit board 216 mounted thereon is seated, and the first body 212a may be formed to surround one side of the pressure sensor module 211. However, the first body 212a forms an opening region so that the first circuit board 216 may be exposed.

The pressure sensor module 211 is seated on the first body 212a, and the O-ring 215 is inserted between the pressure sensor module 211 and the second body 212b. The plate 214, which includes an opening region coaxial to a center region of the O-ring 215, has a lager outer circumference than the outer circumference of the O-ring 215, and the plate 214 is coupled to the second body 212b.

The second body 212b includes an opening region overlapping the opening region of the plate 214. Air passes through the opening region so that pressure may be measured.

The second body 212b is formed to face the first body 212a. The first and second bodies 212a and 212b and the plate 214 may be fastened to each other by screws 213. The pair of screws 213 pass through the second body 212b, the plate 214, and the first body 212a. Thus, the pressure sensor module 211 may be stably fastened between the first and second bodies 212a and 212b.

Referring to FIG. 3B, the pressure sensor module 211 includes a pressure sensor 211a, a housing 211b, and a second O-ring 211c.

The housing 211b has an inner space where the pressure sensor module 211 is seated. A support wall 211b″ for surrounding and fastening a side surface of the pressure sensor module 211 is formed. The second O-ring 211c is inserted between the pressure sensor module 211 and the support wall 211b″.

The housing 211b includes a vent hole 211b′ formed to communicate with the inner space in order to allow air to pass therebetween. Preferably, the vent hole 211b′ is formed to face the pressure sensor 211a. The vent hole 211b′ is placed to overlap the opening regions of the second body 212b and the plate 214.

A circuit board 211d is connected to the pressure sensor 221a, and the housing 211b is formed to accommodate the pressure sensor 211a equipped with the circuit board 211d.

According to this embodiment, the housing of the pressure sensor unit may accommodate the pressure sensor without movement and also may prevent the inflow of water by the first and second O-rings.

Also, the first and second bodies that accommodate the housing prevent vibration and movement of the housing by supporting lower and upper portions and a side surface of the housing. Accordingly, it is possible to minimize effects of movement. In addition, it is possible to block water flowing into electronic components even if a fiber material such as Gore-Tex is not disposed on the front surface so that water does not flow into the watch-type terminal 100. Therefore, it is possible to implement a pressure sensor unit capable of accurate measurement because a waterproof pressure sensor is directly exposed to air or water.

Accordingly, the watch-type terminal 100 can withstand a higher water pressure than a pressure sensor unit using Gore-Tex, and thus may sense water pressure in a deep region (e.g., in a water depth of 50 m).

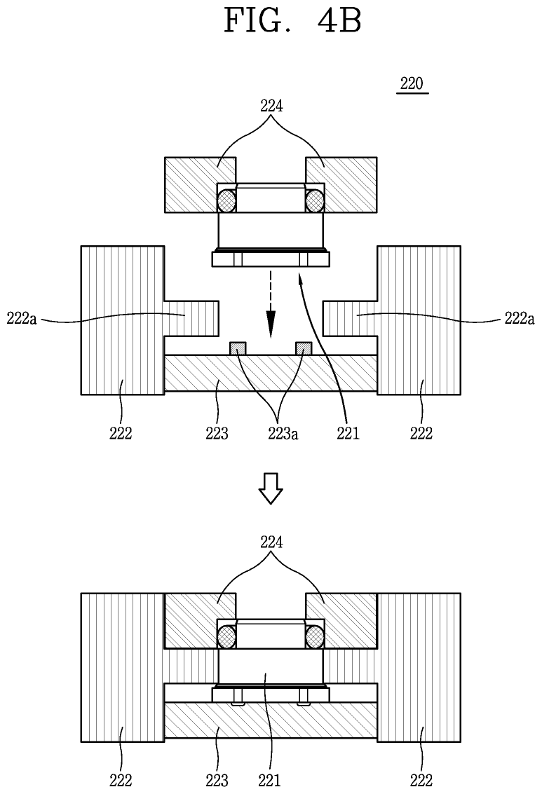

FIGS. 4A and 4B are conceptual diagrams illustrating the structure of a pressure sensor unit according to another embodiment.

Referring to FIG. 4A, a pressure sensor unit 220 includes a pressure sensor 221 seated in a housing 222, a socket 224 fastened to the pressure sensor 221, and a circuit board 223 connected to the pressure sensor 221.

An O-ring 225 is mounted on an outer circumferential surface of the pressure sensor 221. The socket 224 is inserted into the pressure sensor 221 with the O-ring interposed therebetween. The socket 224 is formed to surround the outer circumferential surface of the pressure sensor 221, and a hole 224′ is formed to provide a space allowing the inflow of air (or water) to the pressure sensor 221.

The pressure sensor module equipped with the circuit board 223 and the socket 224 is seated in the housing 222. The housing 222 has a support wall 222a protruding from an inner surface of the housing to support a side surface of the pressure sensor 221. The socket is inserted into an upper portion of the support wall 222a, and the circuit board 223 is seated in a lower portion of the support wall 222a while being electrically connected to the pressure sensor 221.

A C-clip 223a is formed in the circuit board 223 in order to electrically connect the pressure sensor 221 and the circuit board 223.

A surface where the socket 224 and the housing 222 are in contact with each other is process for bonding so that the housing 222 is fastened to the socket 224. Thus, it is possible to prevent the inflow of water.

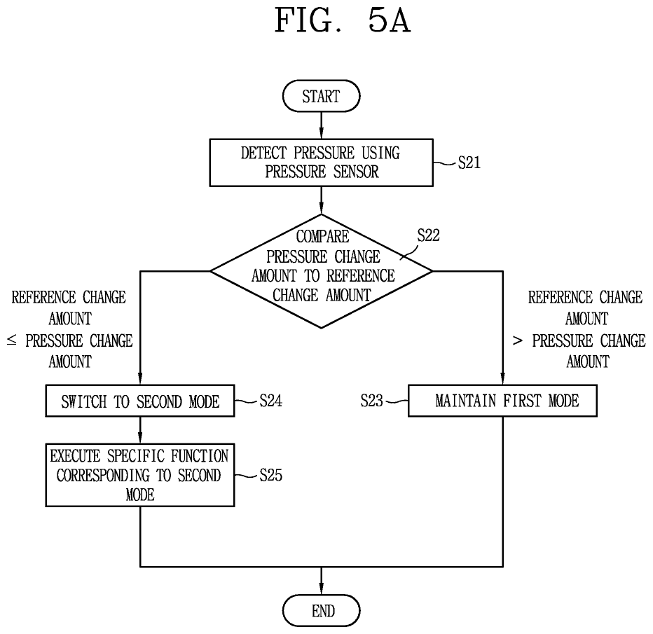

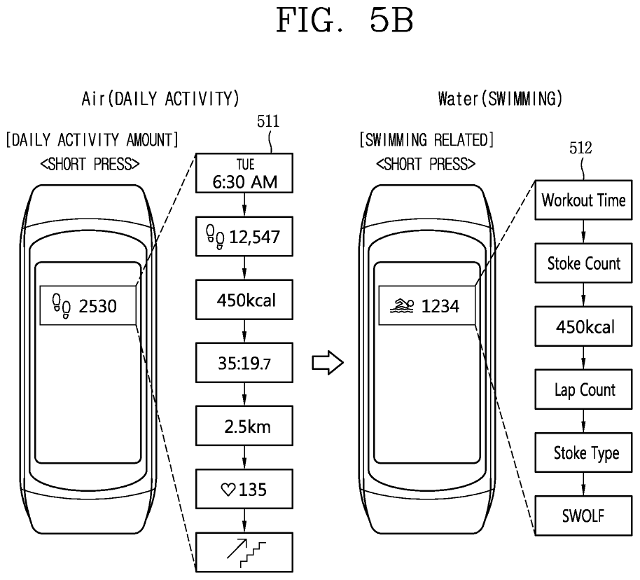

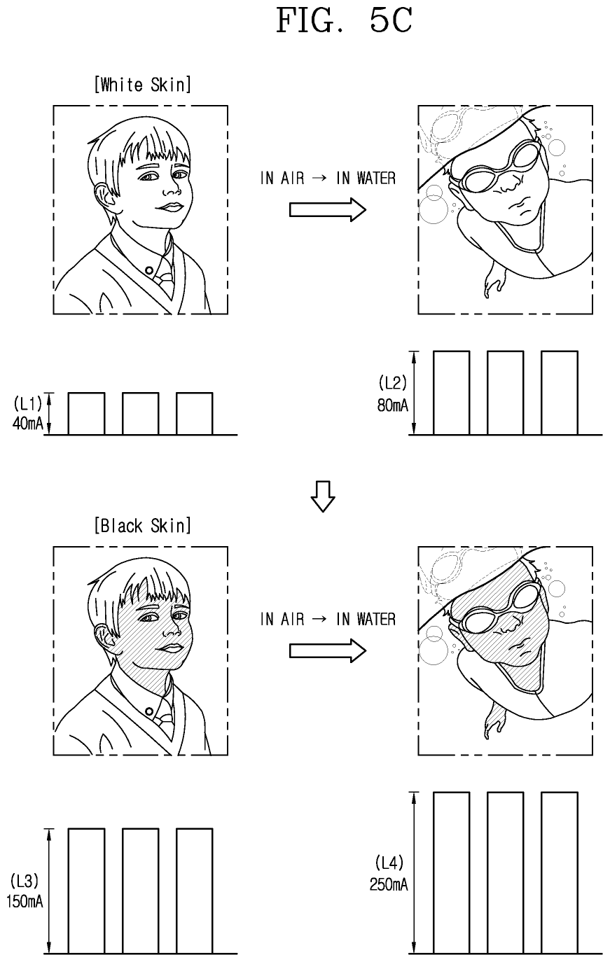

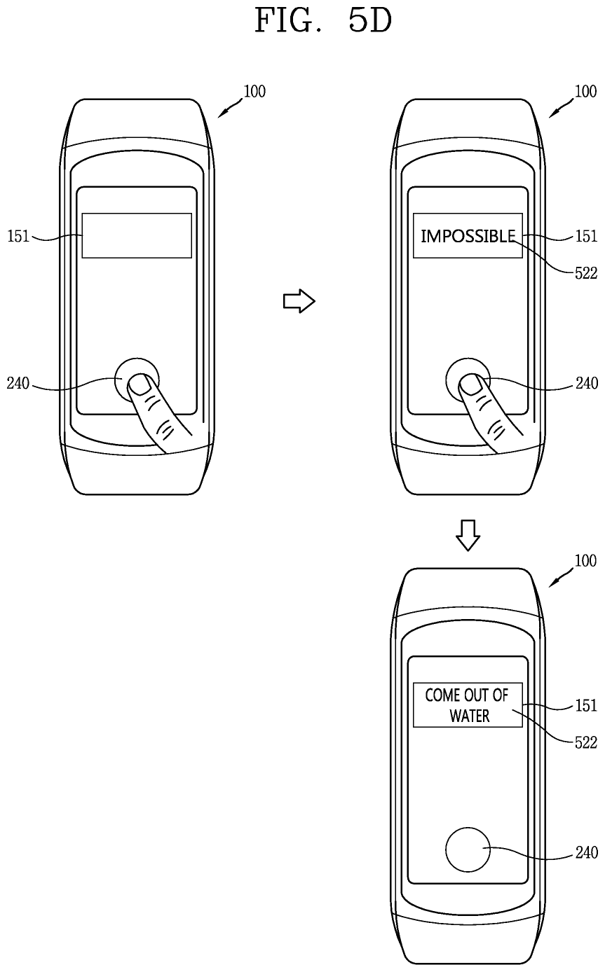

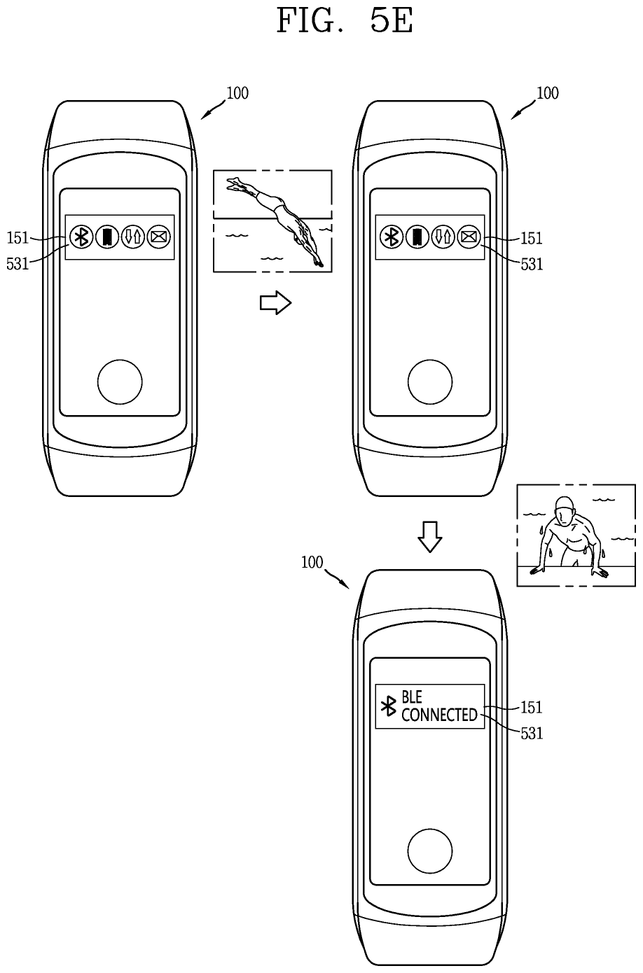

FIG. 5A is a flowchart illustrating a method of controlling a watch-type terminal according to an embodiment. FIG. 5b is a conceptual diagram illustrating a method of controlling a watch-type terminal according to an embodiment of the present invention.

Pressure is detected by the pressure sensor 200 (S21). The control unit 180 may activate the pressure sensor 200 at specific periods or may activate the pressure sensor 200 according to the user's settings. The control unit 180 may perform control such that the detected pressure value is stored in the memory 170.

The control unit 180 compares a pressure change measured by the pressure sensor to a reference change amount (S22). The reference change amount may be set by an average pressure change amount corresponding to a case in which the watch-type terminal 100 moves from land to water.

While the watch-type terminal 100 is located on land, the control unit 180 enables the watch-type terminal 100 to operate in an on-land mode, i.e., a first mode when the pressure change is smaller than the reference change amount (S23).

In the first mode, when the watch-type terminal 100 is activated on land, the control unit 180 may execute a necessary application, activate a specific function, or output or store specific information.

Meanwhile, when the detected pressure change amount is greater than or equal to the reference change amount, the control unit 180 switches the on-land mode to an underwater mode, i.e., a second mode (S24). In the second mode, the control unit 180 executes a specific function (S25). The specific function of the second mode may enable the watch-type terminal 100 to execute a necessary application in water, activate a specific function, or output or store specific information.

That is, the control unit 180 may execute different functions and applications in the first mode and the second mode. The control unit 180 may change an operation mode of the watch-type terminal 100 without a user's control command Although not shown, when the pressure change amount detected by the pressure sensor 200 is greater than or equal to the reference change amount in the underwater mode, i.e., the second mode, the control unit 180 changes the second mode to the first mode. Accordingly, the user does not need to apply a control command to change a mode for executing a necessary function according to an external environment.

Referring to FIG. 5B, the display unit 151 selectively outputs first images 511 in the first mode. The control unit 180 may control the display unit 151 to change and output the first images 511 on the basis of a control command applied by the user input unit 123 in the first mode. The first images 511 may include first information regarding the current date, weather, and time or may include second information regarding a step count, calories consumption, a distance traveled, a pulse, a stair climb, and the like. The second information may correspond to information collected when the watch-type terminal 100 is located on land or information regarding functions executable on land.

Meanwhile, when a pressure change amount detected in the first mode is greater than or equal to the reference change amount, the control unit 180 switches from the first mode to the second mode. The display unit 151 outputs second images 512 in the second mode. The control unit 180 may control the display unit to sequentially output the second images 512 on the basis of a control command applied by the user input unit 123. The second images 512 may include the first information and third information.

The third information may include information to be collected in water by the watch-type terminal 100, for example, at least one of a workout time, a stroke count, consumed calories, a lap count, a stroke type, and SWOLF information which are measured in water.

In the second mode, an image including the second information is not output. That is, the control unit 180 may differently control the images output in the first and second modes.

Thus, the user may receive information necessary in the current state (on land or in water) more quickly through a relatively small display unit.

FIGS. 5C to 5E are conceptual diagrams illustrating a method of controlling a watch-type terminal according to still another embodiment of the present invention.

Referring to FIG. 5C, the control unit 180 collects biometric information through the body composition collecting sensor 240. The body composition collecting sensor 240 may be configured using a PPG sensor having a light emitting unit and a light receiving unit. The body composition collecting sensor 240 outputs light, receives light reflected by a human body, and collects heart rate information. The control unit 180 controls the light emitting unit of the body composition collecting sensor 240 to output a first quantity of light in the first mode in order to collect the heart rate information.

The control unit 180 outputs a different quantity of light depending on a user's skin color. When the user has a black skin, the control unit 180 controls the light emitting unit to output a third quantity L3 of light that is more intense than the first quantity L1 of light. When the light emitting unit outputs a large quantity of light, accurate biometric information may be acquired even though some of the light is absorbed by the skin.

Meanwhile, when the pressure detected by the pressure sensor 200 in the first mode changes more than a reference pressure, the control unit 180 switches the first mode to the second mode. In the second mode, the control unit 180 controls the light emitting unit to output a second quantity L2 of light, the second quantity L2 being larger than the first quantity.

Since more intense light is output in the second mode than in the first mode, it is possible to secure light reaching skin even when light leaks due to the inflow of water between the body composition collecting sensor 240 and the user's skin in water. Accordingly, when the watch-type terminal 100 is located in water, it is possible to stably collect biometric information by increasing the intensity of light compared to the on-land case.

Meanwhile, when the user has a dark skin color and the first mode is switched to the second mode, the control unit 180 may control the light emitting unit to output a fourth quantity L4 of light that is more intense than the third quantity of light.

When the user who has a dark skin color enters water, the control unit 180 may output a large quantity of light in consideration of the amount of light absorbed or leaked and may stably collect biometric information.

According to this embodiment, the control unit 180 may control a bio-collecting function in order to collect information of a substantially constant quality according to the location of the watch-type terminal 100.

A control method for controlling activation of a function of collecting specific information in the first mode and second mode will be described with reference to FIG. 5D. For example, the specific information may correspond to body fat information.

The body composition collecting sensor 240 may include a plurality of electrodes brought into contact with one region of a human body, and the plurality of electrodes are formed on an outer surface of the watch-type terminal 100. The body composition collecting sensor 240 cannot collect accurate body fat information when water is present on the plurality of electrodes.

When a human body region is brought into contact with the electrode of the body composition collecting sensor 240, the control unit 180 controls the body composition collecting sensor 240 in the first mode to collect body fat information. The display unit 151 outputs body fat information 521 detected by the body composition collecting sensor 240 in the first mode.

Meanwhile, the control unit 180 switches the first mode to the second mode on the basis of a pressure change detected by the pressure sensor 200. The control unit 180 controls the body composition collecting sensor 240 such that body composition information is not collected in the second mode. Thus, even when a portion of a human body is brought into contact with the electrode of the body composition collecting sensor 240, the control unit 180 may deactivate the body composition collecting sensor 240.

When a portion of the human body is brought into contact with the electrode of the body composition collecting sensor 240, the control unit controls the display unit 151 to output warning information 522 for informing that measurement is not possible. Also, when a continuous measurement attempt (contact with an electrode) is detected, the warning information 522 may correspond to a message saying “Exit the water” or a message or image indicating “Body fat measurement cannot be performed.”

According to this embodiment, when accurate information cannot be collected in water, the control unit 180 deactivates an information collection function. Thus, it is possible to prevent the provision of unclear data.

Referring to FIG. 5E, the control unit 180 activates at least one predetermined function in the first mode. For example, the function may correspond to a wireless communication function (Bluetooth function). The display unit 151 may output an image 531 indicating the activated function.

Meanwhile, the first mode is switched to the second mode. In the second mode, the control unit 180 deactivates a specific function. The specific function may correspond to a function that is not necessary or cannot be stably executed when the watch-type terminal 100 is located in water. That is, the specific function is limited when a distance from an external device increases or when a wireless communication function is not stably performed or is not necessary.

The control unit 180 deactivates the specific function when the first mode is switched to the second mode. When the specific function is deactivated, the display unit 151 outputs an image 531 indicating the inactive state.

Also, the specific function may be activated again when the second mode is switched to the first mode. Although not shown, the control unit may deactivate the specific function in the first mode and may activate the specific function in the second mode.

That is, when the first mode is switched to the second mode, the control unit 180 activates or deactivates the specific function without the user's control command Thus, it is possible to stably operate the watch-type terminal 100 and minimize power consumption.

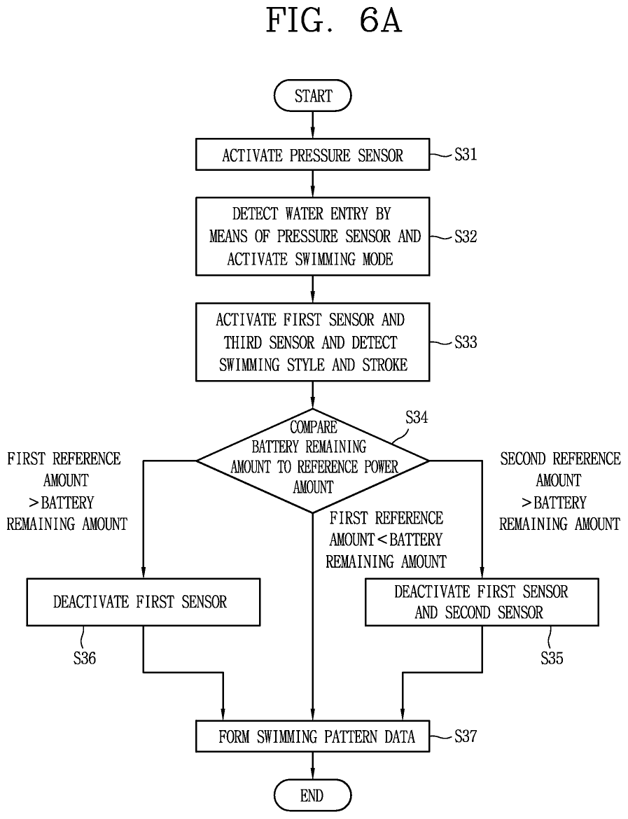

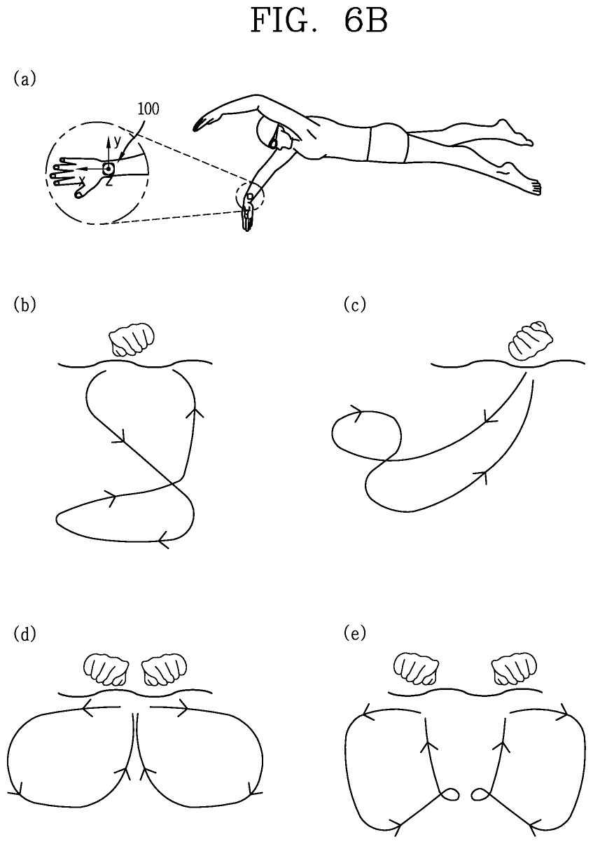

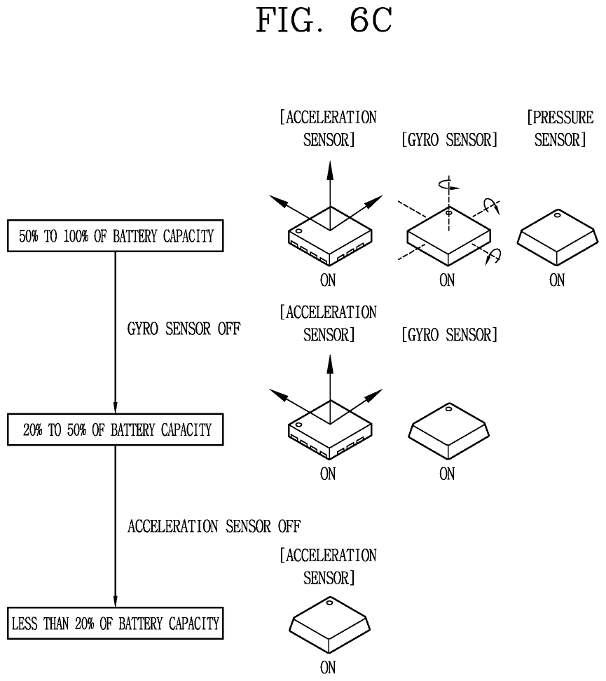

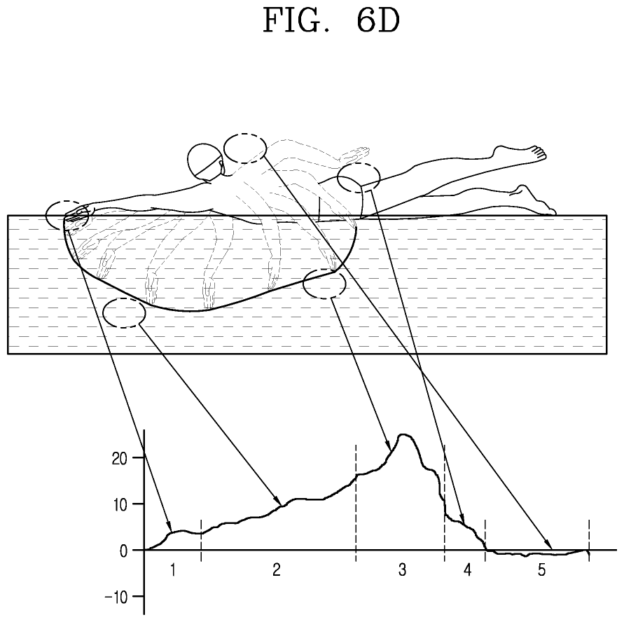

FIG. 6A is a flowchart illustrating a method of controlling a watch-type terminal according to another embodiment of the present invention. FIG. 6B is a conceptual diagram illustrating a stroke pattern detected by at least one sensor included in a sensing unit of the present invention.

FIG. 6C is a conceptual diagram illustrating sensors activated to acquire swimming tracking information.

Referring to FIGS. 6B and 6C, when a user is in water, the control unit forms swimming tracking information using the pressure sensor 200 and a gyro sensor and an acceleration sensor included in the sensing unit 140.

When the first mode is switched to the second mode, the control unit 180 may detect a movement pattern of the wrist wearing the watch-type terminal 100 using at least one of the pressure sensor 200, the gyro sensor, and the acceleration sensor.

The control unit 180 detects the direction of rotation of the user's wrist using the gyro sensor and detects the direction of movement of the wrist using the acceleration sensor. Also, by using the pressure sensor 200, the control unit 180 may detect a pressure change in water and a point at which the wrist moves into or out of water.

Accordingly, the gyro sensor, the acceleration sensor, and the pressure sensor may be used to collect tracking information during swimming Thus, it is possible to acquire and analyze a swimming style and stroke information.

FIG. 16B(A) shows that a user is swimming with the watch-type terminal 100 worn on a wrist. FIGS. 6B(B), 6B(C), 6B(D), and 6B(E) show swimming patterns analyzed as the freestyle stroke, the backstroke, the breaststroke, and the butterfly stroke.

FIG. 6D is a conceptual diagram showing a pressure change detected by a pressure sensor during underwater swimming

When a user swims with the watch-type terminal 100 worn on his or her wrist, the watch-type terminal 100 repeats the movement into and out of water along with the movement of the wrist. Also, a pressure change caused by the movement of the wrist is detected in water. Thus, the control unit 180 may detect a pattern of the pressure change to detect a pattern and stroke of the swimming As shown in FIG. 6D, the pressure change in water is detected as being relatively large (10 hPa at a change of 0.1 m). Also, the pressure change caused by the movement of the wrist out of water is relatively small (10 hPa at a change of 85 m). Accordingly, it is possible to accurately check whether the wrist is placed in or out of water.

The pressure sensor 200 may be used to accurately detect the moment at which the wrist enters water. Thus, it is possible to accurately detect a stroke.

The pressure sensor 200, the gyro sensor, and the acceleration sensor have different current consumption while the sensors operate. The battery consumption is in the following order: gyro sensor, acceleration sensor, pressure sensor.

Referring to FIGS. 6A and 6C, when a user wearing the watch-type terminal 100 enters water while the pressure sensor 200 is activated (S31), the control unit 180 detects the entrance on the basis of a pressure change detected by the pressure sensor 200 and activates a swimming mode, i.e., a second mode (S32).

The control unit activates first to third sensors in the second mode to perform control such that a swimming style and a stroke (S33). Here, the first sensor corresponds to the gyro sensor, the second sensor corresponds to the acceleration sensor, and the third sensor corresponds to the pressure sensor 200. When the first to third sensors are activated, the control unit may calculate SWOLF information through a swimming style, a stroke count, and a lap count.

The first sensor may be used to acquire directional information of the wrist in a specific posture.

The control unit 180 compares the remaining amount of battery power to reference power (S34). When the remaining amount of battery power is less than a first reference, the control unit deactivates the first sensor (S36). Thus, the control unit 180 forms swimming pattern data using the second sensor and the third sensor (S37). For example, when the remaining amount of battery power ranges from about 50% to about 100%, the control unit 180 activates all of the first to third sensors.

On the other hand, when the remaining amount of battery power is less than a second reference, the control unit 180 deactivates the first sensor and the second sensor (S35). The second reference is smaller than the first reference. For example, the control unit 180 forms the swimming pattern data through information detected by only the third sensor (S35).

Even when a swimming pattern is detected using only the pressure sensor 200, it is possible to determine whether the wrist is in or out of water, and it is also possible to detect the speed at which the wrist moves in water. Accordingly, it is possible to analyze a pattern in water and a pattern out of water to calculate a stroke count, and thus it is possible to acquire swimming pattern data including stroke information. However, when the gyro sensor is deactivated, it is not possible to analyze a rotational angle, and thus it is difficult to accurately acquire information regarding swimming styles.

That is, only the second and third sensors are activated when the remaining amount of battery power ranges from 20% to 50%, and the swimming pattern data is formed through information detected using only the third sensor, which is the pressure sensor.

Thus, it is possible to minimize battery consumption, and also it is possible to acquire swimming pattern data while the user is in water.

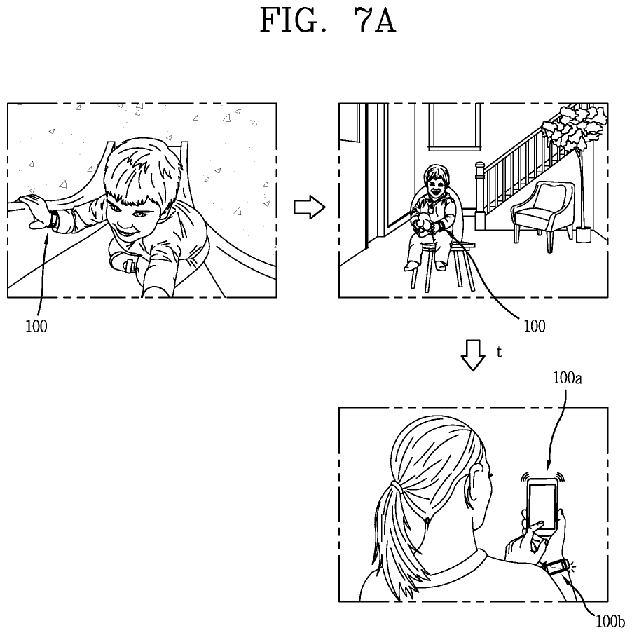

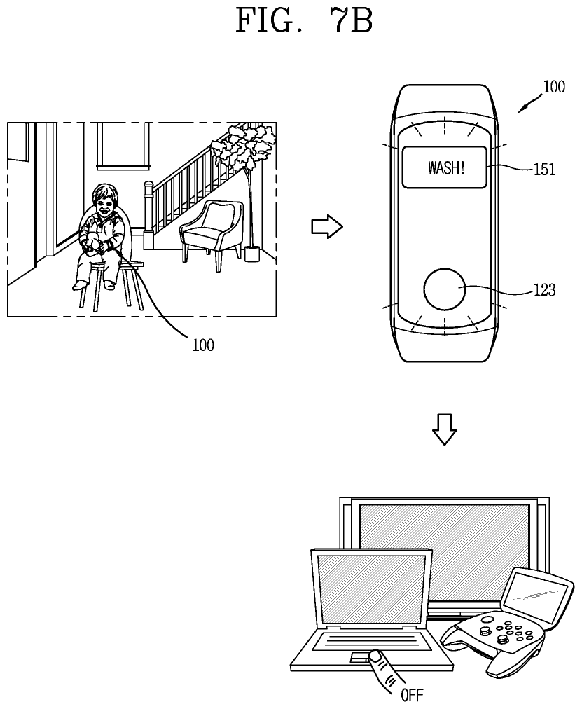

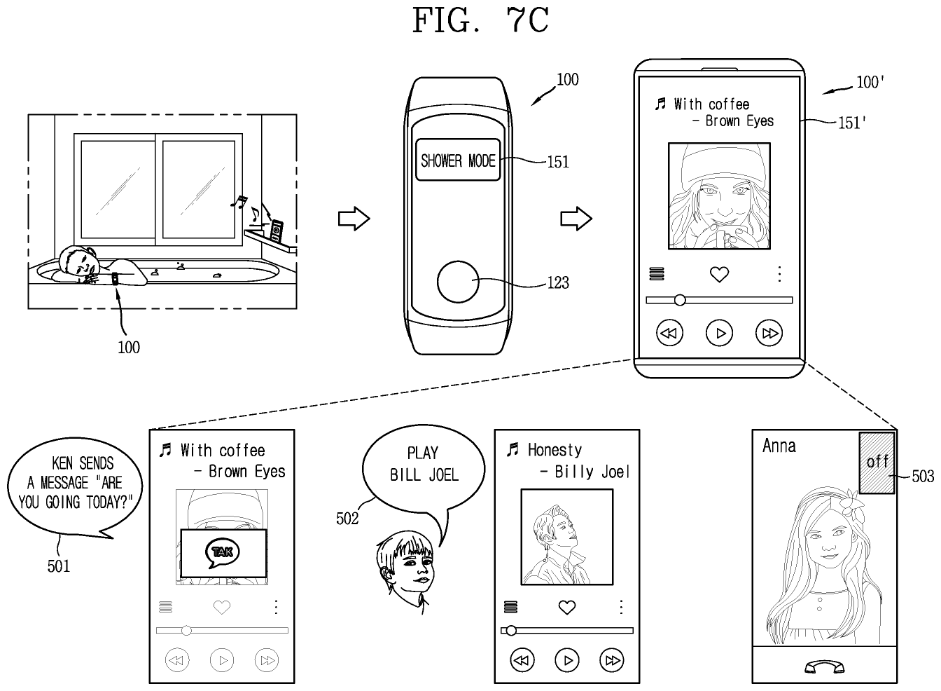

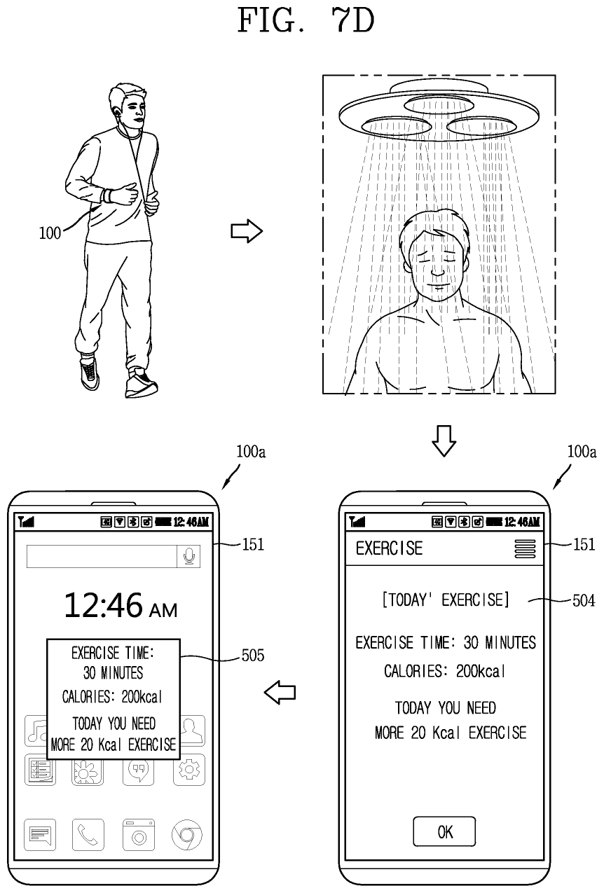

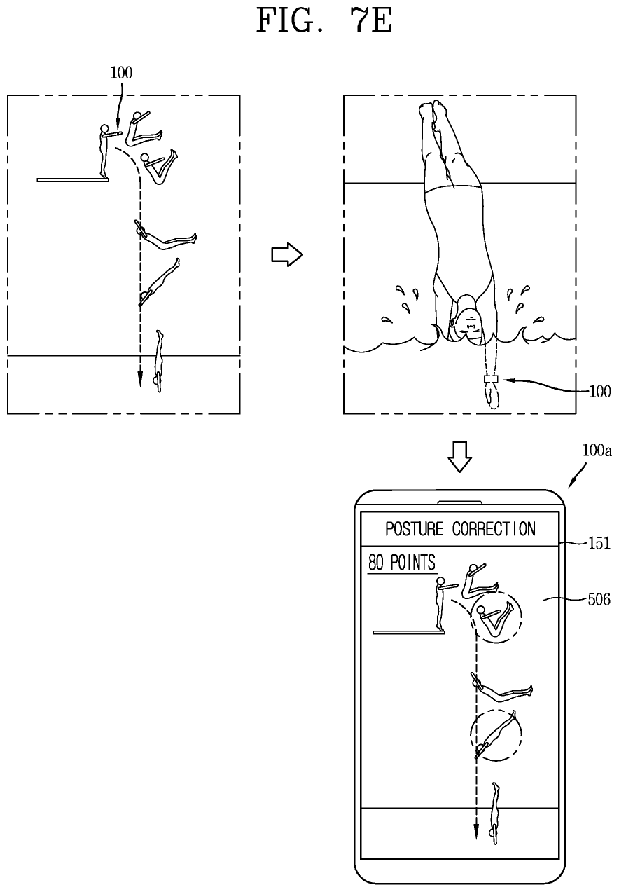

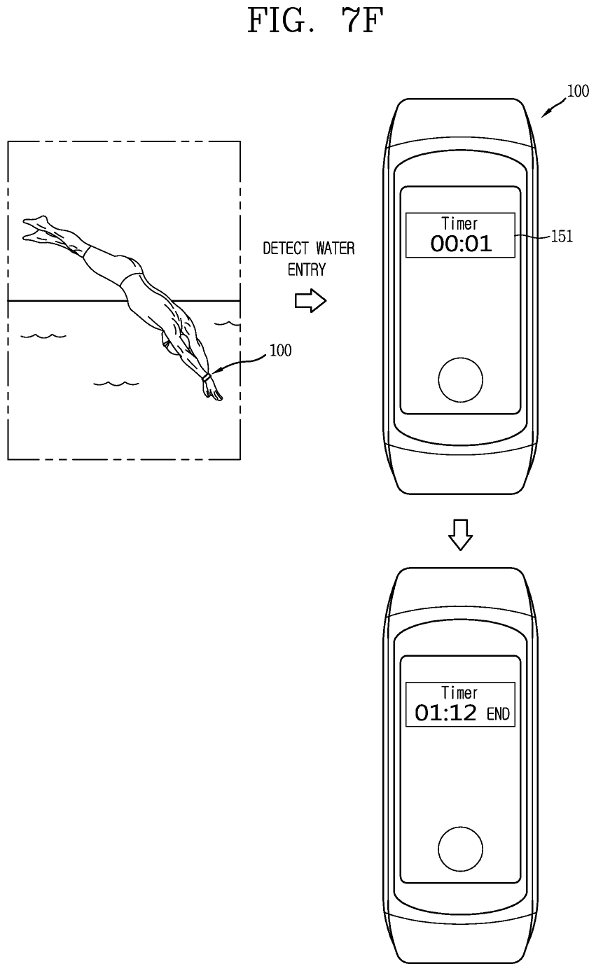

FIGS. 7A to 7F are conceptual diagrams illustrating a method of controlling a watch-type terminal according to an embodiment of the present invention.

Referring to FIG. 7A, a pressure sensor and a location sensor included in the watch-type terminal 100 is used to output a user's degree of cleanliness. For example, the location sensor of the watch-type terminal 100 may be used to determine the user's location. After the user enters a room from the outside, the pressure sensor may be used to determine whether the user puts his or her hands in water and washes them.

The control unit 180 controls the pressure sensor 200 to detect whether the watch-type terminal 100 enters water within a specific period of time after the user moves to the room. Also, when the water entry is not detected within a specific time t, the control unit 180 transmits warning information to specific mobile terminals which are connected in a wireless manner, or the watch-type terminal 100 outputs specific warning information.

Referring to FIG. 7B, when the watch-type terminal 100 is moved from the outside to the inside, the control unit 180 outputs, to the display unit 151, guidance information instructing to wash hands within a specific time or immediately. Also, when a movement into water is not detected by the pressure sensor 200, the control unit 180 determines that the hands are not washed and deactivates a predetermined external device.

Also, the control unit 180 may limit activation of the external device or may transmit radio signals to the external device so that a specific function is not executed.

Referring to FIG. 7C, the control unit 180 determines that a user is taking a shower on the basis of hydraulic pressure detected by the pressure sensor 200 and humidity and motion information detected by other sensors.

The control unit 180 may switch the watch-type terminal 100 to a shower mode, and may switch an external device 100′ connected to the watch-type terminal 100 in a wireless manner to the shower mode. Thus, it is possible to control the external device even when the user does not change an operation mode of the external device.

For example, when a message is received in the shower mode, the external device 100′ transforms the message into voice data and then output the voice data. Also, the external device 100′ may recognize the user's voice command to perform a specific function.

When a video call is received in the external device 100′ in the shower mode, a camera for photographing a user is deactivated without an additional control command

Referring to FIG. 7D, the control unit 180 determines whether the user is exercising by using a motion sensor, a PPG sensor, or the like. Also, when it is determined by the pressure sensor 200 that the user is located in water, the control unit 180 determines that the exercise is finished and calculates exercise data.

The control unit 180 may transmit the exercise data to the external device 100′, and the external device 100′ may output the external data 504 and an exercise analysis result 505 to the display unit.

Referring to FIG. 7E, it may be determined that the user did diving on the basis of a pressure change detected by the pressure sensor 200. In this case, the control unit 180 may form posture data obtained by analyzing movement prior to water entry, by using sensors included in a sensing unit.

The posture data 506 may be output by an external device 100a. Thus, the user may acquire information regarding the posture before water entry without taking a picture or applying a specific control command.

The control unit 180 may form the posture data through information regarding movement prior to a specific time, from the water entry time acquired by the pressure sensor 200.

Referring to FIG. 7F, the control unit 180 may find out a time at which the user entered water and a time at which the user came out of water by using the pressure sensor 200. That is, when the water entry is detected by the pressure sensor 200, the control unit 180 may activate a stopwatch function to start time measurement. When the user comes out of water, the control unit 180 may stop the time measurement and measure a time of period during which the user has been in water. Thus, the user may conveniently measure a swimming time and/or a diving time without separately recording the time at the time of water entry.

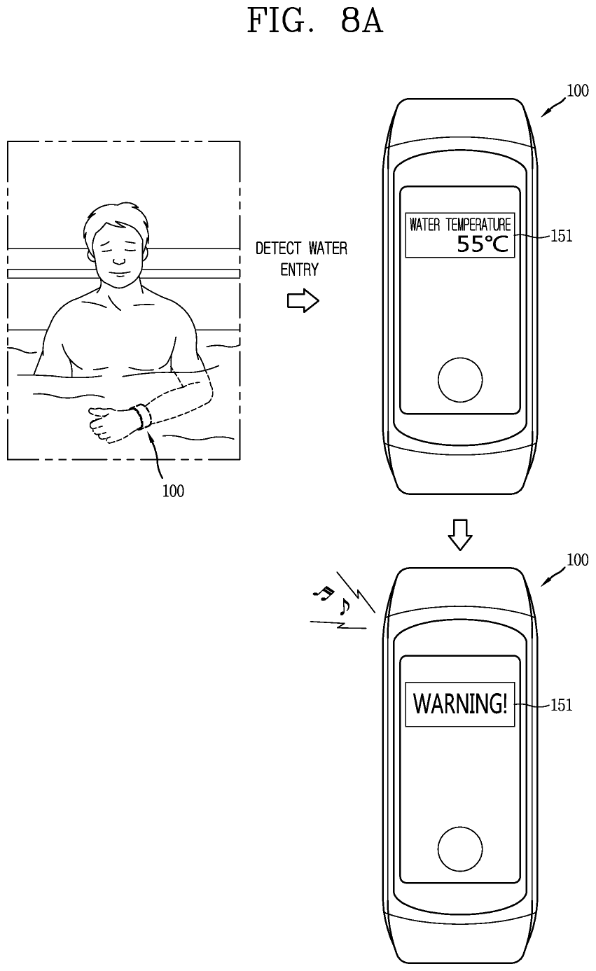

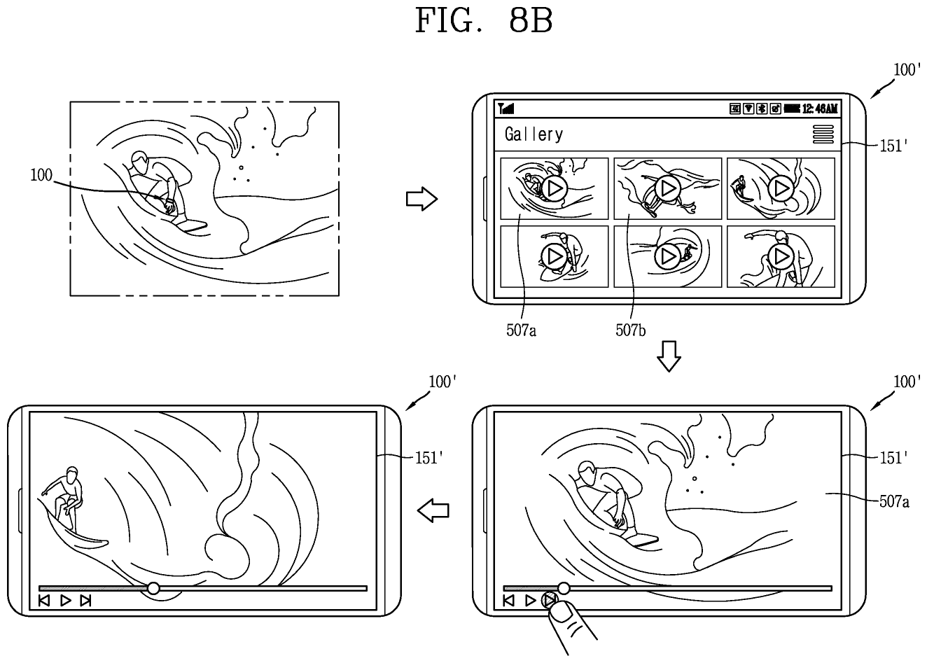

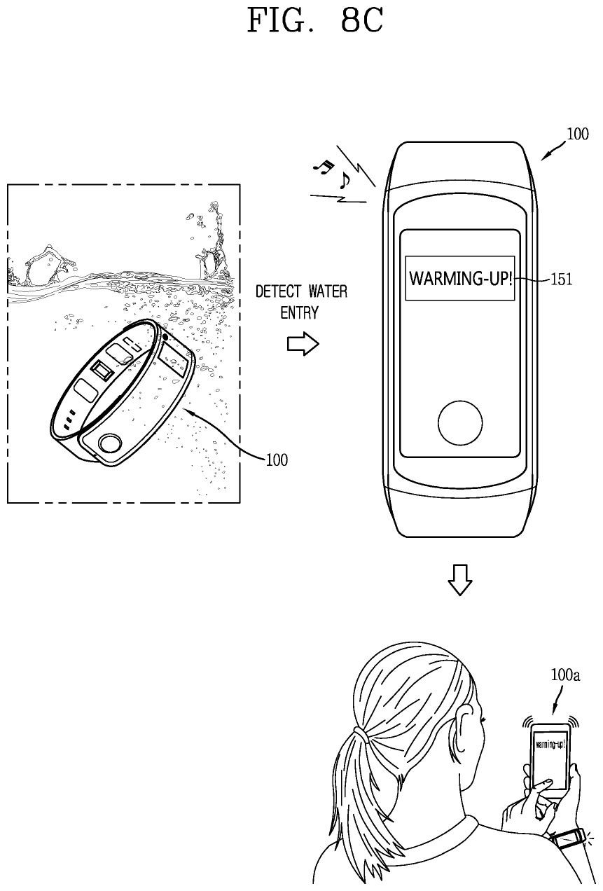

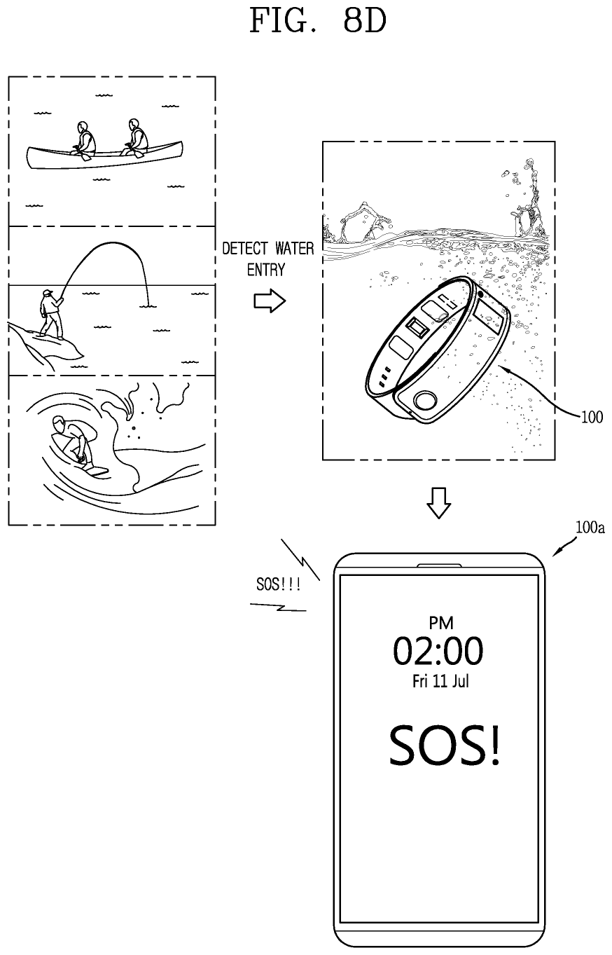

FIGS. 8A to 8D are conceptual diagrams illustrating a control method for outputting warning information according to an embodiment of the present invention.

Referring to FIG. 8A, the control unit 180 may detect water entry through the pressure sensor 200 and may activate a temperature sensor. The display unit 151 may output water temperature information.

When it is detected that the user is located in water for a specific time, the control unit 180 outputs warning information. The warning information may be composed of an image, text, or sound information. The specific time may be set by user health information stored in the memory 170 or by measured biometric data.

Referring to FIG. 8B, while an image is captured by a camera included in an external device installed in or interoperable with the watch-type terminal 100, the pressure sensor 200 detects a pressure change. The control unit 180 extracts a time at which the user entered water and a time at which the user moved to land on the basis of the pressure change, and divides captured continuous images on the basis of the times.

That is, the continuous images may be partitioned into an image part 507a captured while the user is in the water and an image part 507b captured while the user is out of the water.

Referring to FIG. 8C, when it is determined by the pressure sensor 200 that the user moves into the water, the control unit 180 controls the display unit 151 to output warning information. However, the warning information may be implemented as sound, vibration, or the like as well as an image.

On the other hand, when it is determined by the pressure sensor 200 that the user is still located in the water, the watch-type terminal 100 transmits a warning message to a predetermined external device.

Referring to FIG. 8D, when it is detected by the pressure sensor 200 that the user enters the water, the control unit 180 may control a wireless communication unit to transmit SOS information to an external device 100a.

For example, the control unit 180 may transmit the SOS information only when it is determined that the water entry is sudden on the basis of an activity log of the user stored in the memory 170 or motion and movement information of the user detected by a sensor included in a sensing unit.

According to these embodiments, it is possible to output specific warning information when the user performs appropriate water entry or a dangerous situation occurs due to sudden water entry.

According to these embodiments, it is possible to prevent a danger by providing information to a user or a third party when the user is in a dangerous situation contrary to the user's will or when the user is in water undesirably to his or her health.

The foregoing configuration of the present invention may be implemented as a computer-readable code in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

### INDUSTRIAL APPLICABILITY

The present invention provides a watch-type terminal capable of detecting a movement to water or land and being controlled according to the detecting result. Accordingly, the present invention may be utilized in various related industrial fields.

What is claimed is:

1. A watch-type terminal comprising:
a main body capable of being mounted on a region of a human body;
a pressure sensor mounted on a region of the main body in an on-land mode and configured to detect an external pressure change; and
a control unit configured to switch the on-land mode to an underwater mode to control execution of a specific function when the pressure change is greater than or equal to a predetermined reference change amount.

2. The watch-type terminal of claim 1, wherein when the underwater mode is activated, the control unit executes a first function corresponding to the underwater mode and blocks execution of a second mode corresponding to the on-land mode.

3. The watch-type terminal of claim 2, further comprising a photoplethysmography (PPG) sensor configured to measure a biometric signal, the PPG sensor including a light emission unit for emitting light and a light reception unit for receiving light reflected by skin,
wherein the control unit controls the light emission unit in order to enhance the quantity of light output in the underwater mode.

4. The watch-type terminal of claim 2, further comprising a user input unit configured to receive a user's control command, wherein
the control unit selectively outputs first images on the basis of a control command applied to the user input in the on-land mode and sequentially outputs second images on the basis of the control command in the underwater mode, and
at least one piece of information included in the first images is different from that of information included in the second images.

5. The watch-type terminal of claim 1, further comprising a first sensor configured to detect rotation and a second sensor configured to detect speed in order to form swimming pattern data along with the pressure sensor in the underwater mode,
wherein the control unit compares a current battery remaining amount to a reference amount and sequentially deactivates the first sensor and the second sensor.

6. The watch-type terminal of claim 1, further comprising a sensing unit configured to detect a location of the main body,
wherein the control unit outputs warning information when a pressure change due to movement into water is not sensed by the sensing unit within a specific time after a user moves from outside to inside.

7. The watch-type terminal of claim 1, further comprising a wireless communication unit configured to perform wireless communication with an external device,
wherein when the on-land mode is switched to the underwater mode, the control unit controls the wireless communication unit to transmit a radio signal including a command for switching to the underwater mode to the external device.

8. The watch-type terminal of claim 1, further comprising a pressure sensor module including the pressure sensor,
wherein the pressure sensor module comprises:
a housing having an inner space so that the pressure sensor is placed therein and having a vent hole formed in a region; and
an O-ring inserted between the pressure sensor and the housing.

9. The watch-type terminal of claim 1, further comprising a pressure sensor unit including the pressure sensor module,
wherein the pressure sensor module comprises:
first and second bodies placed to face each other such that the pressure sensor unit is supported;
a plate placed on a surface of the second body, the plate including a first opening region corresponding to a region of the pressure sensor unit;
an O-ring inserted between the plate and the pressure sensor module to prevent inflow of water; and
a screw configured to fasten the first and second bodies to the plate,
wherein the second body includes a second opening region corresponding to the first opening region of the plate.

10. The watch-type terminal of claim 9, wherein the housing is placed between the first body and the second body such that the vent hole overlaps the first and second opening regions.
